(19) United States
(12) Patent Application Publication
(10) Pub. No.: US 2005/0288010 A1
(43) Pub. Date: Dec. 29, 2005

(54) Radio communication apparatus and radio communication method

(75) Inventor: Takeyuki Kobayashi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/167,144

(22) Filed: Jun. 28, 2005

(30) Foreign Application Priority Data
Jun. 29, 2004 (JP) 2004-191498

(51) Int. Cl. H04Q 7/20

(52) U.S. Cl. 455/425; 455/422.1

(57) ABSTRACT

A radio communication apparatus having a communication unit which communicates with equipment AP1 on a wireless network, a first buffer and a second buffer which receive a picture signal from the equipment on the wireless network via the communication unit, converting units which receive the picture signal and convert the picture signal into reproduction information, and a control unit which first stores the picture signal in the second buffer, when a storage area of the second buffer is full, storing the picture signal in the first buffer, when the first buffer is full, sequentially supplying the picture signal stored in the second buffer to the converting unit while storing the picture signal in the first buffer, and when the storage area of the second buffer is empty, controlling supply of the picture signal so as to sequentially supply the picture signal to the converting unit.

### CROSS-REFERENCE TO RELATED APPLICATIONS

This application is based upon and claims the benefit of priority from prior Japanese Patent Application No. 2004-191498, filed Jun. 29, 2004, the entire contents of which are incorporated herein by reference.

### BACKGROUND OF THE INVENTION

1. Field of the Invention

The present invention relates to a radio communication apparatus such as a wireless local area network (LAN), and particularly relates to a radio communication apparatus and a radio communication method for transferring the relatively large volume audio and video contents or the like at high speed.

2. Description of the Related Art

In recent years, in accordance with diffusion of digital equipment, for example, a communication apparatus using a digital signal such as a wireless LAN has been widely spread. As such a radio communication apparatus, for example, a radio communication apparatus for transmitting and receiving the digital video contents by mediating between a hard disk recorder and a digital television or the like in the home may be considered in addition to a computer network.

In such a radio communication apparatus, usually, reproduction has been started since a network receiving buffer has been full. However, when starting reproduction of a picture signal, the buffer of an MPEG decoder is empty and the radio communication apparatus takes in data from the receiving buffer without stopping and processes it, which may cause under flow. In addition, the radio communication apparatus transfers the data to the MPEG decoder without stopping, so that a throughput of the network may be rapidly lowered by temporarily occupying an inner bus. Therefore, there is fear that a picture is distorted when starting the reproduction.

According to a picture receiving terminal device disclosed in Patent document 1 (Jpn. Pat. Appln. KOKAI Publication No. 2003-289526), a calculation unit is provided as a measure of such under flow. The calculation unit calculates a threshold value for under flow control of the amount of data stored in a buffer by using data length information for the each frame when receiving picture contents in order to rationally and effectively proceed the reproduction processing in the case of reproducing a picture signal while downloading a content file. By using this threshold value, the picture receiving terminal device controls the under flow of the buffer.

However, according to this prior art, there is a problem such that a large memory capacity is required not only when starting the reproduction with the under flow generated but also when transferring the data with a capacity of the buffer due to the threshold value.

### BRIEF SUMMARY OF THE INVENTION

An embodiment of the present invention is a radio communication apparatus comprising: a communication unit which communicates with equipment on a wireless network by transmitting and receiving a radio signal; a first buffer which receives a picture signal from the equipment on the wireless network via the communication unit; a second buffer which receives a picture signal from the equipment on the wireless network via the communication unit; a converting unit which converts the picture signal from the first and second buffers into reproduction information and outputting the information; and a control unit which first stores the picture signal received from the communication unit in the second buffer; when a storage area of the second buffer is full, stores the picture signal in the first buffer; when the first buffer is full, sequentially supplies the picture signal stored in the second buffer to the converting unit while storing the picture signal in the first buffer; and when the storage area of the second buffer is empty, controls supply of the picture signal so as to sequentially supply the picture signal stored in the first buffer to the converting unit.

### BRIEF DESCRIPTION OF THE SEVERAL VIEWS OF THE DRAWING

FIG. 1 is a block diagram showing an example of a configuration of a radio communication apparatus according to an embodiment of the present invention;

FIG. 2 is a block diagram showing an example of a configuration of a radio transmission processor of the radio communication apparatus according to the embodiment of the invention;

FIG. 3 is a system diagram showing an example of a network that uses the radio communication apparatus according to the embodiment of the invention;

FIG. 4 is a block diagram showing another example of the configuration of the radio communication apparatus according to the embodiment of the invention;

FIG. 5 is a flow chart showing an example of the buffer processing of the radio communication apparatus according to the embodiment of the invention; and

FIG. 6 is a flow chart showing another example of the buffer processing of the radio communication apparatus according to the embodiment of the invention.

### DETAILED DESCRIPTION OF THE INVENTION

Embodiments of the present invention will be described in detail with reference to the drawings.

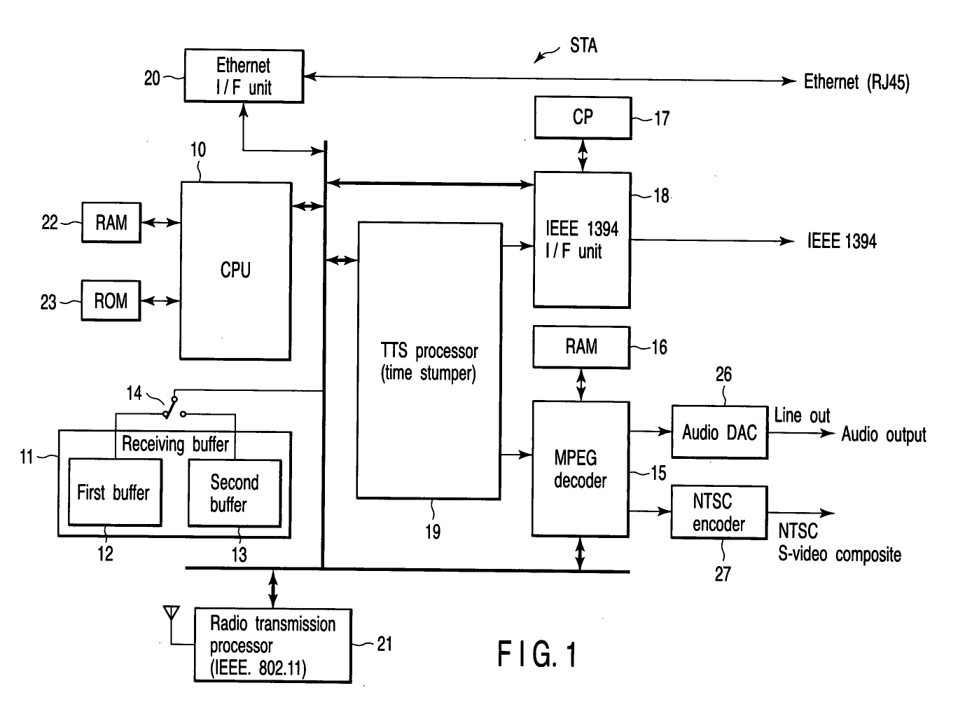

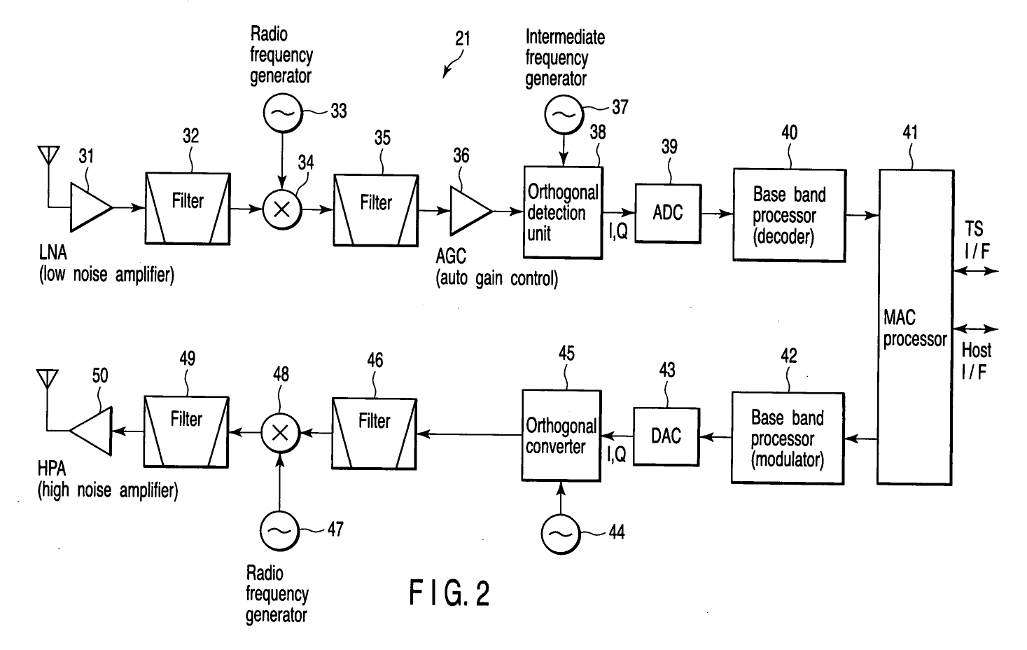

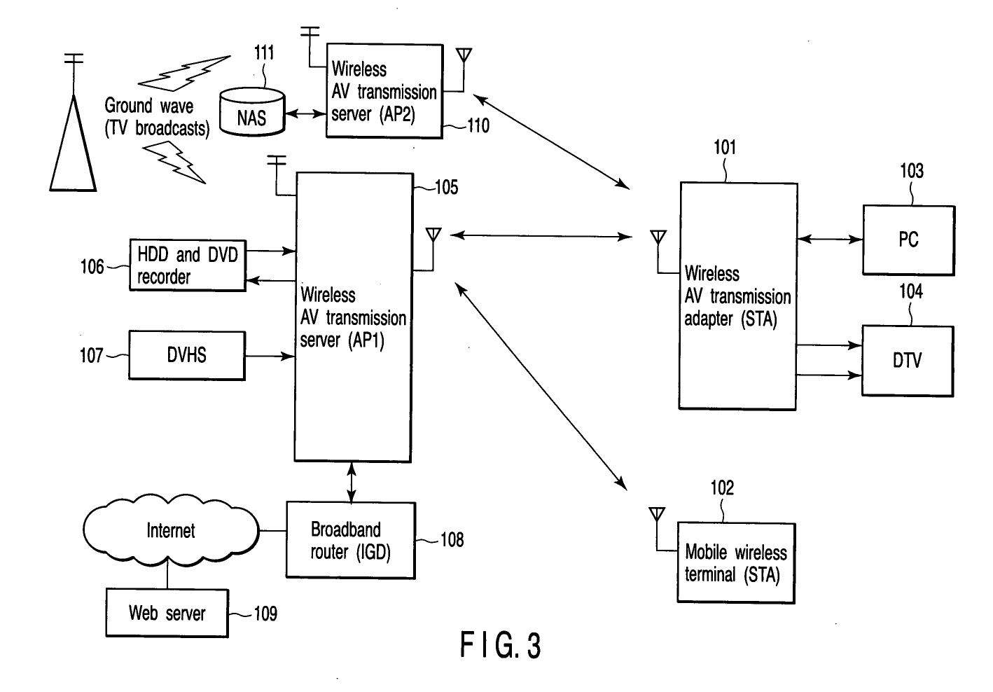

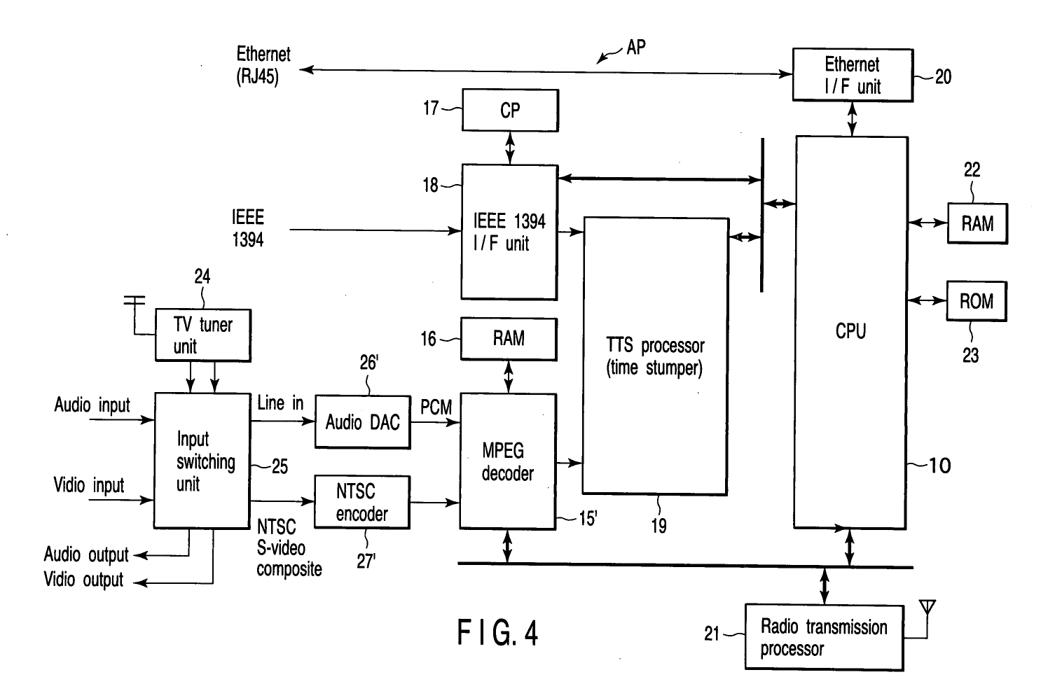

A radio communication apparatus according to an embodiment of the present invention has a plurality of receiving buffers, and for example, when receiving the content data and starting the reproduction, the radio communication apparatus smoothly reproduces content data by receiving a picture signal using two buffers and supplying it to an MPEG decoder. Then, the radio communication apparatus receives the picture signal only by one buffer and may supply the picture signal to the MPEG decoder or the like. Accordingly, it is possible to smoothly carry out the communication and the reproduction processing while efficiently using a storage capacity of a buffer memory. Here, FIG. 1 is a block diagram showing an example of a configuration of the radio communication apparatus according to the embodiment of the invention; FIG. 2 is a block diagram showing an example of a configuration of a radio transmission processor of the radio communication apparatus thereof; FIG. 3 is a system diagram showing an example of a network that uses the radio communication apparatus thereof; and FIG. 4 is a block diagram showing another example of the configuration of the radio communication apparatus thereof.

<An Example of a Radio Communication Apparatus According to an Embodiment of the Present Invention>

(Configuration)

Wireless AV Transfer Adapter (STA)

First, an example of the configuration of the radio communication apparatus according to the embodiment of the invention will be described below with reference to the drawings. The radio communication apparatus according to the embodiment of the invention can be realized by various configurations. As an example thereof, the buffer processing of an embodiment of the invention as a configuration of a wireless AV transmission adapter STA that is one transfer system composed of a wireless AV transmission server AP and the wireless AV transmission adapter STA will be described in detail below with reference to the drawing.

In this case, as shown in FIG. 1, the wireless AV transmission adapter STA as an example of the radio communication apparatus according to the invention has a CPU 10 for controlling the entire apparatus; a ROM 22 and a ROM 23 connected to the CPU 10 via a data bus; a receiving buffer 11 (including a first receiving buffer 13 and a second receiving buffer 13 incorporated in the receiving buffer) connected to the CPU 10 via the data bus; a switch 14 for controlling the connections of the first receiving buffer 12 and the second receiving buffer 12 to the data bus; a RAM 26 connected to the switch 14; and a TTS processor (time stumper) 19 for making to conform timing of each signal upon communication. In addition, the wireless AV transmission adapter STA has an MPEG decoder 15 that is connected to the data bus and converts a picture signal into the MPEG data; an audio DA converter 26 for particularly carrying out digital-analog conversion of an audio signal; and an NTSC encoder 27 for carrying out the NTSC encode processing.

Further, as a communication function, the wireless AV transmission adapter STA has an Ethernet I/F unit 20 that is connected to the data bus to carry out the communication in conformity with an Ethernet protocol; an IEEE 1394 I/F unit 18 for carrying out the communication in conformity with an IEEE 1394 protocol; a copy right protection unit 17 that is connected to an IEEE 1394 I/F unit 18; and further, a radio transmission processor 21 for carrying out the radio communication in conformity with a radio protocol, for example, IEEE 802.11 (that is not limited to this protocol) or the like.

Further, as shown in FIG. 2, the radio transmission processor 21 has a low noise amplifier 31 for receiving a radio signal via an antenna; a filter 32 connected to the low noise amplifier 31; an adder 34 for receiving the output of the filter 32 and the output of a radio frequency generator 33; a filter 35 for receiving the output; and an automatic gain controller 36 for controlling a gain automatically upon receipt of the output as a configuration for the receiving processing. Further, the radio transmission processor 21 has an orthogonal detection unit 38 for receiving the output of the automatic gain controller 36 and receiving the output of an intermediate frequency generator 37; an A/D converter 39 for A/D converting the output; a base band processor (decoder) 40 for decoding the output; and a media access control processor 41 for relating the communication processing to each medium upon receipt of the output. Further, the radio transmission processor 21 has a base band processor (modulator) 42 for receiving the output of the media access control processor 41; a D/A converter 43 for carrying out the D/A conversion upon receipt of this output; and an orthogonal converter 45 for receiving the output and the output of an intermediate frequency generator 44 as a configuration for the transmission processing. Further, the radio transmission processor 21 has a filter 46 for receiving the output from the orthogonal converter 45; an adder 48 for adding the output of the filter 46 and the output from a radio frequency generator 47; a filter 49 for receiving the output; and a high output amplifier 50 for amplifying a radio signal upon receipt of the output from the filter 49. The radio transmission processor 21 outputs the amplified signal from the antenna.

Wireless AV Transmission Server (AP1)

In the next place, the configuration of the wireless AV transmission server AV, which is the radio communication apparatus of the counter part of the wireless AV transmission adapter STA, will be described below with reference to the drawings. A wireless AV transmission server AP1 at least serves to transmit the content information (the picture information) to the wireless AV transmission adapter STA. As shown in FIG. 4, the wireless AV transmission server AP has a CPU 10 for controlling the entire apparatus; a RAM 22 and a ROM 23 connected to the CPU 10 via a data bus; an input switching unit 25 that is connected to, for example, a hard disk recorder or the like, receives the audio input, the video input, and the audio input, is connected to a television tuner 24, and further output the audio output and the video output; an audio DA converter 26 that is supplied with line-in from the input switching unit 25 and carries out the digital-analog conversion of an audio signal; a NTSC decoder 27′ for supplying NTSC, S-video, and composite or the like from the input switching unit 25; an MPEG encoder 15′ for converting the picture signal into the MPEG data upon receipt the outputs of these audio AD converter 26′ and the NTSC decoder 27′; a RAM 16 that is connected to the MPEG encoder 15′; and a T (time stumper) TS processor 19 that is connected to the data bus and making to conform timing of each signal upon communication. In addition, the wireless AV transmission adapter STA has an Ethernet I/F unit 20 that is connected to the data bus to carry out the communication in conformity with an Ethernet protocol; an IEEE 1394 I/F unit 18 for carrying out the communication in conformity with an IEEE 1394 protocol; and further, a radio transmission processor 21 for carrying out the radio communication in conformity with a radio protocol, for example, IEEE 802.11 (that is not limited to this protocol) or the like.

(System Configuration)

The wireless AV transmission server AP1 and the wireless AV transmission adapter STA having such a configuration respectively configure a communication system as shown in FIG. 3. As shown in FIG. 3, the communication system has a wireless AV transmission adapter (STA) 101 as the side of reception (also, the transmission is possible), for example, a PC (Personal Computer) 103 and a digital television 104 that are connected to the wireless AV transmission adapter (STA) 101. The wireless AV transmission adapter (STA) 101 in this case may has a form of an IC card or the like or may has a form of a communication module incorporated in the PC 103 and the digital television 104.

Further, the communication system includes the mobile wireless terminal (STA) 102 as the side of reception (also, the transmission is possible), and the mobile wireless terminal 102 includes, for example, the structures of a PDA and a cellular phone.

Still further, the communication system has the wireless AV transmission server AP1 and a wireless AV transmission server (AP2) 110 as the side of transmission (also, the reception is possible). Here, for example, a hard disk and DVD recorder 106, a digital video recorder 107, and a broadband router 108 are connected to the AV transmission server AP1, and a web server 109 is connected to the broadband router 108 via the Internet. In addition, the wireless AV transmission server (AP2) 110 is connected to a NAS 111 or the like for receiving a ground wave (the TV broadcasts) or the like.

(Operation).

Between the wireless AV transmission server (AP1) 105 and the wireless AV transmission adapter (STA) 101, for example, the content data or the like supplied from the HDD/DVD recorder 106 is transmitted to the wireless AV transmission adapter (STA) 101 by means of a radio signal via the wireless AV transmission server 105. The wireless AV transmission adapter (STA) 101 receives the radio signal due to the operation of the radio transmission processor 21, for example, in conformity with the protocol of the IEEE 802.11, further. The wireless AV transmission adapter (STA) 101 stores the radio signal in a storage area by using the receiving buffer 11 (to be described later) and sequentially supplies it to the MPEG decoder 15. A content signal that is decoded by the MPEG decoder 15 is further converted by the audio DA converter 26, the NTSC encoder 27 and the like and then, it is outputted via the output terminal to be displayed, for example, on a screen of the digital television 104 or the like shown in FIG. 3.

<Buffer Processing Using Receiving Buffer>

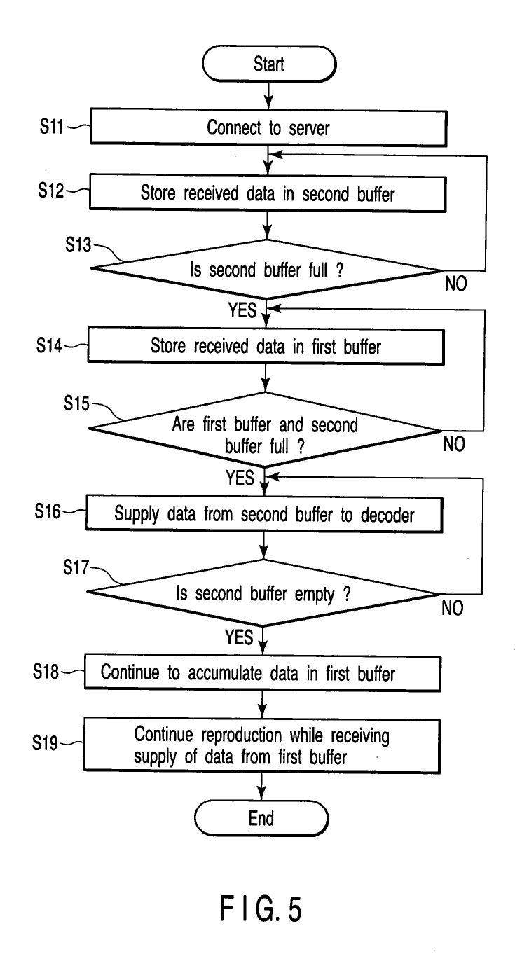

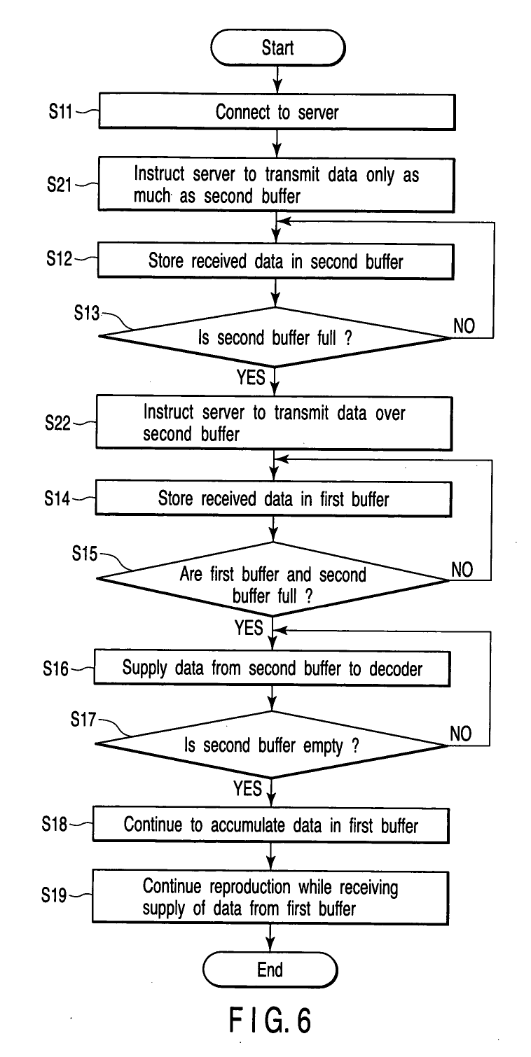

Next, the receiving processing of the picture signal of the wireless AV transmission adapter (STA) 101 using the receiving buffer 13 in a plurality of buffer areas 12 and 13 will be described in detail below with reference to the drawings. FIG. 5 is a flow chart showing an example of the buffer processing of the radio communication apparatus according to the embodiment of the invention, and FIG. 6 is a flow chart showing another example of the buffer processing of the radio communication apparatus according to the embodiment of the invention. In the meantime, the following receiving processing was described above in the case of using the radio transmission processor 21 and the same buffer processing is carried out also by using the Ethernet I/F unit 20 and the IEEE 1394 I/F unit 18.

As shown in FIG. 5, at first, the wireless AV transmission adapter (STA) 101 that is the radio communication apparatus of the embodiment of the invention may be connected to the wireless AV transmission server (AP1) 105 under the control of the control unit 10 (S11). Then, the wireless AV transmission adapter (STA) 101 stores the picture signal or the like received from the wireless AV transmission server (AP1) 105 sequentially in the second buffer 13 (S12).

Here, it is preferable that two receiving buffers are switched using the switch 14 under the control of the control unit 10. However, it is obvious that the same effect and advantage can be obtained by using a plurality of buffer areas, for example, according to a method of dividing the storage area in two by using a large capacity receiving buffer.

Next, if the storage area of the second buffer 13 is full due to such receiving processing (S15), the picture signal or the like is stored in the first buffer 12 (S14). If the first buffer 12 and the second buffer 13 are full due to the transmission processing (S15), the picture signal or the like is supplied from the second buffer 15, for example, to the MPEG decoder 15 (S16). Accordingly, if the storage area of the second buffer 15 is empty (S17), determining that the sate is shifted to a normal state, the data has been continuously accumulated in the first buffer 12 in this time (S18). Then, the reproduction of the picture information has been continued while supplying the picture information or the like to the MPEG decoder 15 (S19).

In this manner, only on start of the reproduction processing, a defect such as interruption of the reproduction of the MPEG decoder 15 or the like can be solved by using the second buffer 13. Further, as described later, it is possible to use the released second buffer, for example, in the rewind reproduction or the like.

(Buffer Processing with Control of Data Transfer Quantity)

Next, the buffer processing with the control of the data transfer quantity will be described below. The flow chart of FIG. 6 shows the buffer processing for controlling the data transfer quantity in accordance with the storage capacity of the second buffer 14.

In other words, as shown in FIG. 6, first, the wireless AV transmission adapter (STA) 101 that is the radio communication apparatus as the embodiment of the invention is connected to the wireless AV transmission server (AP1) 105 under the control of the control unit 10 (S11). Then, the wireless AV transmission adapter (STA) 101 instructs the wireless AV transmission server (AP1) 105 to transmit the data only of the second buffer 13 (S21). Then, the picture signal or the like received from the wireless AV transmission server (AP1) 105 is stored in the second buffer 13 sequentially (S12).

In the next place, if the storage area of the second buffer 13 is full due to such reception processing (S15), the wireless AV transmission adapter (STA) 101 instructs the wireless AV transmission server (AP1) 105 to transmit the data over the capacity of the second buffer (S22). Then, the picture signals or the like received in accordance with this transmission instruction is stored in the first buffer 12 in this time (S14). Due to these transmission processing, if the first buffer 12 and the second buffer 13 are full (S15), the picture signal or the like is supplied from the second buffer 15, for example, to the MPEG decoder 15 (S16). Consequently, if the storage are of the second buffer 15 is empty (S17), determining that the state is shifted to the normal state, the data has been continuously accumulated in the first buffer 12 in this time (S18). Then, the reproduction of the picture information has been continued while supplying the picture information or the like from the first buffer 12, for example, to the MPEG decoder 15 (S19).

In this manner, particularly, by controlling the data transfer quantity from the wireless AV transmission adapter 101 in accordance with the capacity of the second buffer, it is possible to carry out the more reliable smooth reproduction on start of the reproduction.

(Method of Using Second Buffer)

Next, another embodiment of using the storage area of the second buffer that is released after the reproduction is started in other processing will be described in detail below. In other words, when reproducing the picture signal supplied via the network in the radio communication apparatus according to the embodiment of the invention, it is possible to smoothly reproduce the picture by using the second buffer on start of the reproduction. However, the second buffer is used only when starting the reproduction of the picture, and the second buffer is released in other processing, so that it is possible to carry out the reproduction processing more smoothly by appropriately using this area.

Here, it is preferable to form a continuous one ring buffer by using the first buffer (the receiving buffer) 12 and the second buffer (the additional buffer) 13. In the case of executing the ring buffer in a normal receiving buffer, by controlling that a reception position (a data input pointer) does not catch up a reproduction position (a data output pointer) so as to prevent the buffer over run. However, in the case of forming the ring buffer from the first buffer (the receiving buffer) 12 and the second buffer 13, it is controlled that the reproduction position and the reception position are always separated by a size of the second buffer 13. Under such a control, it is possible to secure the old picture data (that as been already reproduced) as much as the volume of the second buffer 13 during the normal reproduction.

By securing such reproduced picture data in the second buffer, the rapid rewind reproduction can be easily carried out in accordance with the instruction of a user.

In other words, in the case that the ring buffer is composed only of the conventional receiving buffer, the old picture data has been discarded, so that receiving the instruction of the rewind reproduction, it is necessary to receive the old picture data once again via the network after evacuating the buffer once. It takes a very long hour from a command of such a rewind reproduction is issued till the picture is rewind-reproduced in practice.

According to the radio communication apparatus of the embodiment of the invention, by using the second buffer that is used only on start of the reproduction for storing the reproduced picture signal during the following reproduction, it is possible to carry out the rapid rewind reproduction upon the rewind reproduction.

In addition, it is obvious that this second buffer can be used not only for storing the reduced picture signal for the rewind reproduction but alto for other purpose, and the present invention provides a radio communication apparatus that serves to smoothly reproduce the picture signal or the like on start of reproduction and further, serves to a high quality reproduction processing or the like and a radio communication method.

In the meantime, according to the above-described embodiment, a plurality of receiving buffer processing is carried out when the radio transmission processor is used, however, the application of the present invention is not limited thereto. The same effect and advantage can be obtained also when the present invention is applied to the IEEE 1394 and the wire communication such as the Ethernet on the basis of the same characteristics.

As described above, according to the radio communication apparatus of the present invention, when the picture signals or the like are accumulated in the buffer, the picture signals are not immediately supplied to a converting unit (for example, an MPEG converting unit) differently from a conventional case, and the picture signals are not supplied to the converting unit at least till the second buffer and the first buffer are full. Accordingly, it is possible to solve a defect generated in the conventional art, namely, a defect that the reproduced image is temporarily interrupted just after the reproduction of the picture is started because the buffer is immediately empty in the reproduction of the picture information started when the buffer is full at once. Such a defect on start of the reproduction is caused because the MPEG decoder processing proceeds quickly since there are few picture signals to be processed by the MPEG decoder or the like upon start of the reproduction so that no picture image is pooled in the buffer temporarily.

Accordingly, by using the second buffer dedicated to start of the reproduction, which is the embodiment according to the present invention, it is possible to eliminate such a state that the pooled picture signal temporally runs short and this makes it possible to carry out smooth and reliable reproduction processing of the picture signal. Particularly, when the picture signal transmitted from a hard disk recorder or the like by the wireless AV transmission server or the like is reproduced by a digital television or the like, for example, via the wireless AV transmission adapter or the like, it is possible to reproduce the picture signal smoothly without interruption of the reproduction.

According to the above-described various embodiments, the present invention can be made by a person skilled in the art. However, a person skilled in the art easily projects these various modifications of these embodiments and the present invention can be applied various embodiments without the inventive skills. Accordingly, the present invention is applied in a wide scope that is not inconsistent with the disclosed principle and a new property not limited to the above-described embodiments.

1. A radio communication apparatus comprising:
a communication unit which communicates with equipment on a wireless network by transmitting and receiving a radio signal;
a first buffer which receives a picture signal from the equipment on the wireless network via the communication unit;
a second buffer which receives a picture signal from the equipment on the wireless network via the communication unit;
a converting unit which converts the picture signal from the first and second buffers into reproduction information and outputting the information; and
a control unit which first stores the picture signal received from the communication unit in the second buffer; when a storage area of the second buffer is full, stores the picture signal in the first buffer; when the first buffer is full, sequentially supplies the picture signal stored in the second buffer to the converting unit while storing the picture signal in the first buffer; and when the storage area of the second buffer is empty, controls supply of the picture signal so as to sequentially supply the picture signal stored in the first buffer to the converting unit.

2. The radio communication apparatus according to claim 1, further comprising: a switch unit which is controlled by the control unit and controls connection among the communication unit, the first buffer, and the second buffer.

3. The radio communication apparatus according to claim 1, wherein the control unit controls the second buffer for a purpose other than the receiving buffer on and after the reproduction of the picture signal is started.

4. The radio communication apparatus according to claim 1, wherein the converting unit includes at least one from among an MPEG decoder, an audio digital/analog converter, and an NTSC encoder.

5. The radio communication apparatus according to claim 1, wherein the communication unit carries out the communication in conformity with a protocol of IEEE 802.11i.

6. The radio communication apparatus according to claim 1, wherein the storage capacity of the first buffer is approximately equal to the storage capacity of the second buffer.

7. The radio communication apparatus according to claim 1, wherein the storage capacity of the first buffer is substantially twice as much as the storage capacity of the second buffer.

8. The radio communication apparatus according to claim 1, wherein the control unit first transmits a signal which requires to transmit only the picture signal as much as the storage capacity of the second buffer to the equipment on the wireless network.

9. The radio communication apparatus according to claim 1, further comprising: an IEEE 1394 interface unit configured to supply the picture signal received from the communication unit to an external device on the network that is in conformity with a protocol of IEEE 1394 when it is controlled by the control unit.

10. The radio communication apparatus according to claim 1, further comprising: an Ethernet interface unit configured to supply the picture signal received from the communication unit to an external device on the network that is in conformity with a protocol of the Ethernet when it is controlled by the control unit.

11. A radio communication method for use in a radio communication apparatus having: a communication unit which communicates with equipment on a wireless network by transmitting and receiving a radio signal; a first buffer which receives a picture signal from the equipment on the wireless network via the communication unit; a second buffer which receives a picture signal from the equipment on the wireless network via the communication unit; a converting unit which converts the picture signal from the first and second buffers into reproduction information and outputting the information; the method comprising:
first storing the picture signal received from the communication unit in the second buffer; when a storage area of the second buffer is full, storing the picture signal in the first buffer; when the first buffer is full, sequentially supplying the picture signal stored in the second buffer to the converting unit while storing the picture signal in the first buffer; and when the storage area of the second buffer is empty, controlling supply of the picture signal so as to sequentially supply the picture signal stored in the first buffer to the converting unit.

12. The radio communication method according to claim 11, wherein the supply of the picture signal is controlled by using a switch unit which controls the connection between the first buffer and the second buffer.

13. The radio communication method according to claim 11, wherein the second buffer is controlled so as to be used for a purpose other than the receiving buffer on and after the reproduction of the picture signal is started.

14. The radio communication method according to claim 11, wherein the converting unit includes at least one among an MPEG decoder, an audio digital/analog converter, and an NTSC encoder.

15. The radio communication method according to claim 11, wherein the communication unit carries out communication in conformity with a protocol of IEEE 802.11i.

16. The radio communication method according to claim 11, wherein the storage capacity of the first buffer is substantially equal to the storage capacity of the second buffer.

17. The radio communication method according to claim 11, wherein the storage capacity of the first buffer is substantially twice as much as the storage capacity of the second buffer.

18. The radio communication method according to claim 11, wherein a signal which requires to transmit only the picture signal as much as the storage capacity of the second buffer is first transmitted to the equipment on the wireless network via the communication unit.

19. The radio communication method according to claim 11, wherein the radio communication apparatus further has an IEEE 1394 interface unit configured to supply the picture signal received from the communication unit to an external device on the network that is in conformity with a protocol of IEEE 1394.

20. The radio communication method according to claim 11, wherein the radio communication apparatus further has an Ethernet interface unit configured to supply the picture signal received from the communication unit to an external device on the network that is in conformity with a protocol of the Ethernet.
